(19) United States
(12) Patent Application Publication
(10) Pub. No.: US 2022/0354724 A1
(43) Pub. Date: Nov. 10, 2022

(54) MOBILE REFRIGERATED HOUSING FOR PORTABLE CADAVER RACK

(71) Applicant: Trailerlogic, LLC, Belton, SC (US)

(72) Inventor: Michael P. Richardson, Clemson, SC (US)

(21) Appl. No.: 17/735,353

(22) Filed: May 3, 2022

Related U.S. Application Data
(60) Provisional application No. 63/184,058, filed on May 4, 2021.

(51) Int. Cl. A61G 17/00; F25D 15/00

(52) U.S. Cl. CPC A61G 17/002; F25D 15/00

(57) ABSTRACT

A portable, refrigerable housing for enclosing a cadaver rack is provided. The walls of the housing are releasably connected and the front wall is formed from individually-openable panels so that individual cadaver compartments may be accessed.

### RELATED APPLICATION

The present application claims the benefit of U.S. Provisional Patent Application No. 63/184,058, filed on May 4, 2021, the entire disclosure of which is incorporated by reference herein.

### FIELD OF THE INVENTION

The present invention relates in general to portable refrigerated housings for portable cadaver racks for temporarily storing cadavers.

### BACKGROUND OF THE INVENTION

In the field, particularly in connection with major catastrophes resulting in loss of lives or overpopulation of hospitals or morgues, a temporary storage facility for cadavers is needed. Such temporary facilities must be mobile and easily set up and broken down for transport to the next site.

The present applicant has developed and patented a collapsible cadaver rack which has become commercially successful and has filled a long-felt need. That collapsible cadaver rack is the subject of U.S. Pat. No. 10,172,749 (“the 749 patent”) and U.S. Pat. No. 11,020,292 (“the '292 patent”), and both of which are incorporated herein in their entireties by reference thereto.

As set forth in the 749 patent and the '292 patent, a collapsible rack for storing and transporting cadavers and human bodies has been developed. That rack is vertically collapsible such that it can be transported with ease. In addition, each rack can be built to hold a number of cadavers on cadaver transfer boards or other supports. For example, a single cadaver rack may house two, three, four, or more cadavers arranged on horizontal adjustable rails in a vertically-stacked orientation.

However, when in the field, and not positioned within a permanent refrigerated structure, the cadavers supported on the rack must be cooled. The present invention relates to a cooled, portable, and modular-designed cadaver rack housing.

The present invention addresses one or more of these long-felt needs.

### SUMMARY OF THE INVENTION

This invention relates generally to portable, flexible, insulated, and refrigerated housings for portable cadaver racks.

Briefly, the present invention is directed, in an embodiment, to a housing in the form of an enclosure with zippered or other closeable soft-sided panels that allow individual access to each cadaver rack space.

In another embodiment, a portable cadaver rack housing comprising a ceiling, a floor, a back wall, two side walls, and a front wall, that when connected together form an enclosed housing that may be cooled for the storage of cadavers is provided. The front wall may comprise multiple individual access panels that allow for entry into individual cadaver rack compartments when a cadaver rack is housed within the portable cadaver rack and a back wall, side wall, front wall and/or ceiling may comprise one or more ports to allow the connection of a refrigeration device to cool the interior of the portable cadaver rack.

In other embodiments, the ceiling, floor, back walls, side walls, and/or front wall may be releasably connected to allow for complete disassembly and re-assembly.

In another embodiment, the portable cadaver rack housing may have its ceiling, back wall, side wall(s) or front wall insulated.

In other embodiment, the portable cadaver rack housing may have a refrigeration device connected via one or more ports.

The accompanying drawings, which are incorporated in and constitute a part of this specification, illustrate one or more embodiments of the invention, and together with the description, serve to explain the principles of the invention.

### BRIEF DESCRIPTION OF THE DRAWINGS

FIG. 1 is an exterior perspective view of the present inventive cadaver rack housing with a connected refrigeration unit for cooling the interior of the housing and keeping the cadaver inside the housing cool.

FIG. 2 is a perspective view of a collapsible portable cadaver rack being encapsulated within the housing of the present invention.

FIG. 3 is a perspective view of the next step in creating the enclosed cadaver rack housing of the present invention.

FIG. 4 is a side view of the next step in creating the enclosed cadaver rack housing of the present invention.

FIG. 5 is a front perspective view showing the interior of the back wall of the inventive cadaver rack housing in place.

FIG. 6 is a front perspective view showing the interior of the back wall, the interior of a side wall, and the exterior of an opposite side wall of the inventive cadaver rack housing in place.

FIG. 7 is a front perspective view illustrating the formed cadaver rack housing of the present invention without refrigeration and showing a front cadaver-accessing wall.

Repeat use of reference characters in the present specification and drawings is intended to represent same or analogous features or elements of the invention.

### DETAILED DESCRIPTION OF PREFERRED EMBODIMENTS

Reference now will be made in detail to the embodiments of the invention, one or more examples of which are set forth below. Each example is provided by way of explanation of the invention, not a limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. The following embodiments and aspects thereof are described and illustrated in conjunction with systems, tools and methods which are meant to be exemplary and illustrative and not limiting in scope. In various embodiments one or more of the above-described problems have been reduced or eliminated while other embodiments are directed to other improvements.

Thus, it is intended that the present invention covers such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

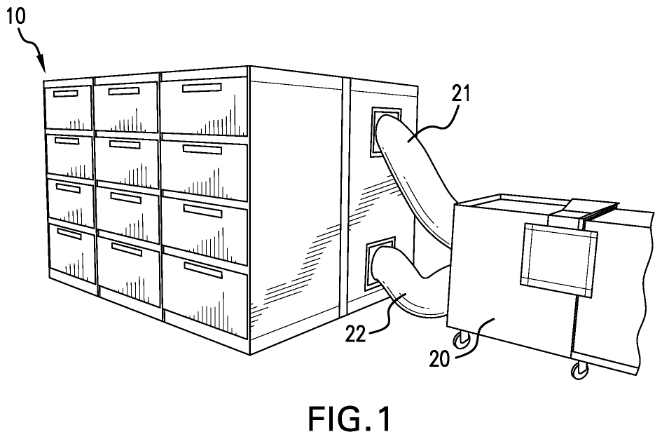

In FIG. 1, an exterior perspective view of the present inventive cadaver rack housing 10 is shown with a connected refrigeration unit 20 for cooling the interior of the housing and keeping the cadaver inside the housing cool. Refrigeration units, which are known in the industry, and any such refrigeration unit may be used in connection with the present cadaver rack housing 10. The refrigeration unit 20 is connected to the housing 10 via tubing or other connection. The refrigeration unit 20 will typically have a cooling air supply tube/duct 21 and a return air tube/duct 22.

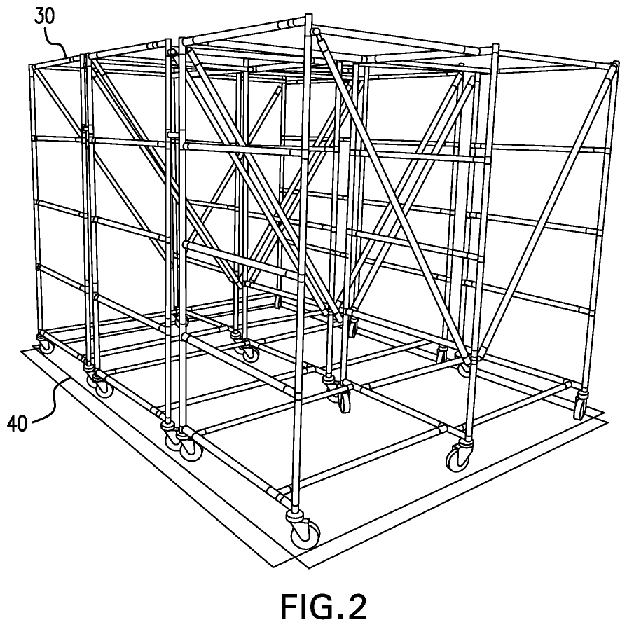

In FIG. 2, a perspective view of a collapsible portable cadaver rack 30 of the type set forth in the 749 patent and the '292 patent being encapsulated within housing 10 is shown. Floor 40 of the present inventive housing 10 is shown in FIG. 2 after it has been placed under the bottom of the cadaver rack 30. Floor 40 may be comprised of a single large panel that constitutes the entire floor 40, or may consist of individual panels connected together to form floor 40. Racks with or without wheels and racks with or without other types of feet may be housed by the present inventive housing 10.

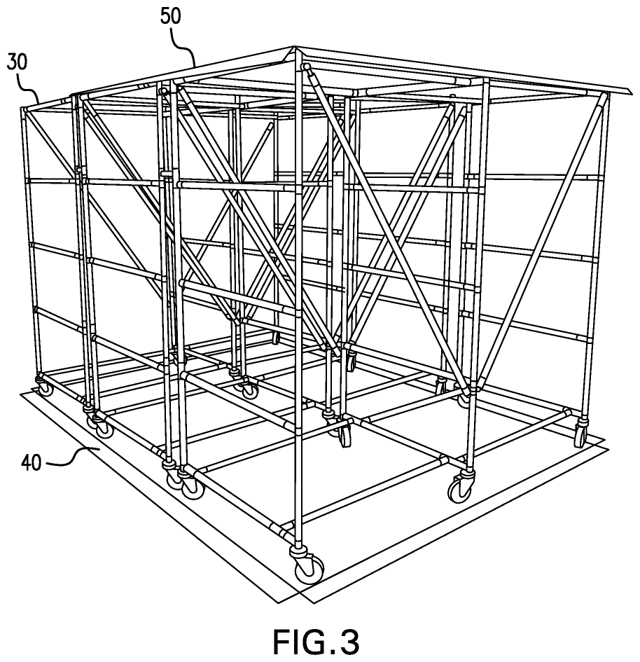

In FIG. 3, a perspective view of the next step in creating the enclosed cadaver rack housing 10 is shown. Ceiling 50 of the housing 10 is shown in place such that it covers the top of the cadaver rack 30. Ceiling 50 may be comprised of a single large panel that constitutes the entire ceiling 50, or may consist of individual panels connected together to form ceiling 50.

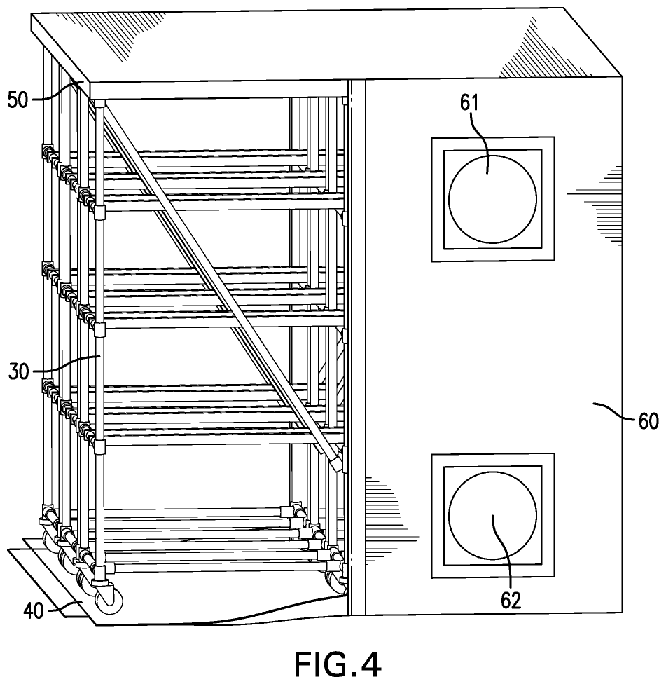

In FIG. 4, a side view of the next step in creating the enclosed cadaver rack housing 10 is shown. Side air flow connection panel 60 is shown after it has been zippered (or velcroed or otherwise attached) to floor 40 and ceiling 50. In an alternative embodiment, side air flow connection panel 60 may be sized (not shown) to cover the entire side wall of the housing 10. In other alternative embodiments, side air flow connection panel 60 itself may be comprised of multiple individual panels connected together. It is to be understood that the side walls and/or panels may be installed in any order that allows them to be connected to adjacent side panels and front and back panels, and to floor 40 and ceiling 50 and may be of any size that would result in a solid wall.

As shown, side air flow connection panel 60 will have one or more ports 61 and 62 for air entry and exit to allow for refrigerated air to cool the interior of the housing 10 and, ultimately, the cadavers stored on cadaver rack 30. As with other sides, walls, floors and ceilings (except the front entry wall), the side air flow connection panel 60 may be a singular piece, or it can comprise multiple individual panels that may be connected together to form a portion of a wall.

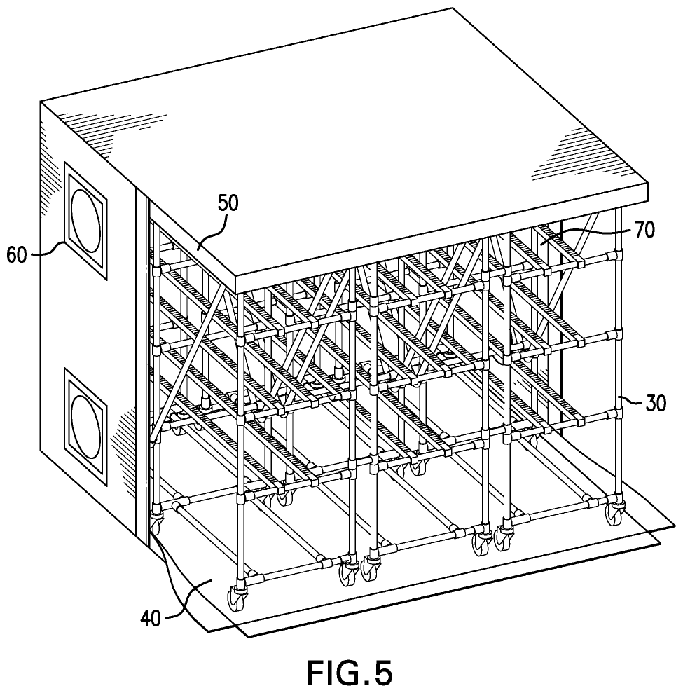

In FIG. 5, a front perspective view showing the interior of back wall 70 of the cadaver rack housing 10 in place is illustrated. Back wall 70 may be formed of a full panel that connects both side walls together with floor 40 and ceiling 50. Alternatively, back wall 70 may be comprised of multiple individual panels that, when connected together, form the entire back wall 70.

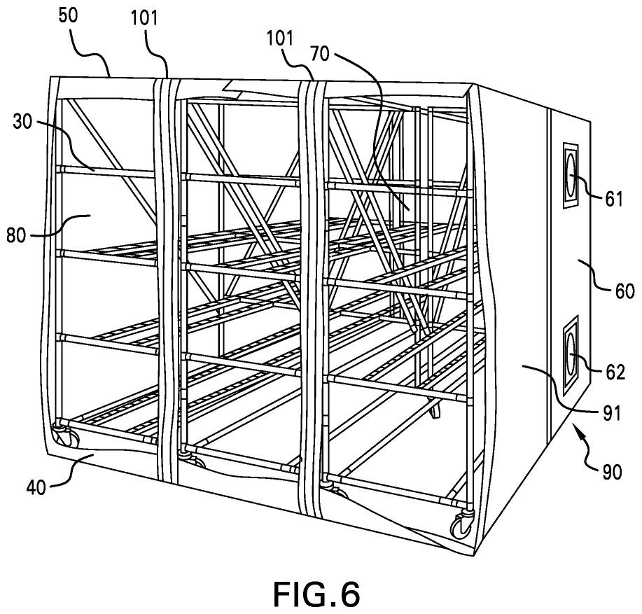

In FIG. 6, a front perspective view showing the interior of back wall 70, the interior of side wall 80, and the exterior of side wall 90 is illustrated. In FIG. 6, side wall 80 has been connected to back wall 70, floor 40, and ceiling 50. As with the other walls, side wall 80 may be comprised of a singular piece that forms the entire wall, or it may be comprised of individual panels that, when connected together, form side wall 80. In addition, front panel connection strips 101 are shown.

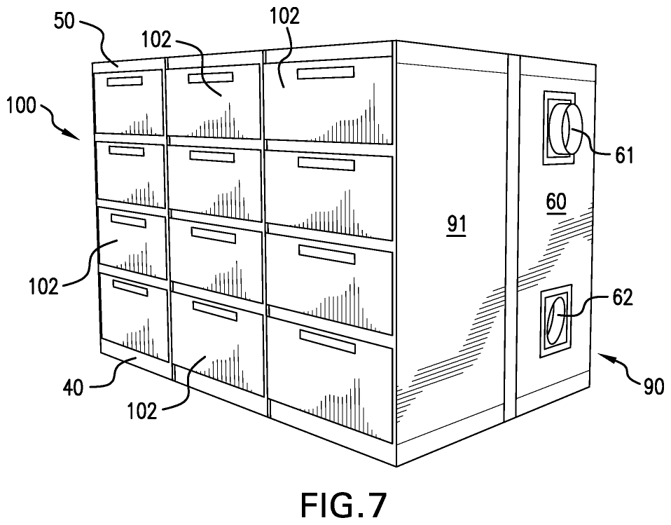

FIG. 7 shows a front perspective view illustrating the formed cadaver rack housing 10 without a refrigeration unit and showing front cadaver-accessing wall 100. As shown in FIG. 7, front cadaver-accessing wall 100 is comprised of multiple individual access panels 102 which function as the “doors” to allow access to each individual cadaver storage compartment. The individual access panels 102 are connected to front panel connection strips 101 (hidden from view in FIG. 7), each other, and to other walls, ceiling 50, and floor 40 as appropriate.

The cadaver rack housing 10 may consist of many individual access panels 102, depending on the size and number of the cadaver racks being housed. The number of individual access panels 102 will generally correspond to the number of cadavers that may be stored in the individual modules of the particular cadaver rack housed therein, but individual access panels may allow access to multiple cadaver storage modules. The use of individual panels to provide access to individual cadaver compartments assists in controlling the loss of cold air when the housing 10 is opened for cadaver entry or removal.

The panels and walls employed in the present inventive housing 10 will typically be multi-layer and insulated. In one embodiment, the panels/walls may have four layers of material, typically a vinyl material, with the outer layers being Herculite®, optionally treated with and/or containing an anti-microbial, such as Microban®, the two center layers being foil-backed insulation material. In an alternative embodiment, some of the panels/wall might not be insulated but be comprised of a simple vinyl material instead. In addition, a solid floor pan, such as one made of vinyl, can be utilized between cadaver rack 30 and floor 40.

Various panel-opening devices may be utilized in the present invention. FIG. 7 illustrates one example—straps or strips 101 that are affixed to each of the individual access panels 102.

Side walls, back walls, and/or panels may be interchangeable so that the side air flow connection panel 60 can be moved to either side (or back) for connection of the refrigeration unit 20.

The inventive housing 10 can be designed in all different sizes. In addition, the housing 10 can be designed to allow for additional modules to be added to either side to increase capacity. Filler panels may also be used within housing 10 to continue adding modules.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and is not intended to limit the invention so further described in such appended claims. Therefore, the spirit and scope of the appended claims should not be limited to the description of the versions contained therein.

What is claimed is:

1. A portable cadaver rack housing comprising a ceiling, a floor, a back wall, two side walls, and a front wall, that when connected together form an enclosed housing that may be cooled for the storage of cadavers,
wherein the front wall comprises multiple individual access panels that allow for entry into individual cadaver rack compartments when a cadaver rack is housed within the portable cadaver rack housing,
wherein one of the back walls, side walls, front wall or ceiling comprises one or more ports to allow the connection of a refrigeration device to cool the interior of the portable cadaver rack housing, and
wherein the ceiling, floor, back walls, side walls, and front wall are releasably connected to allow for complete disassembly and re-assembly.

2. The portable cadaver rack housing of claim 1 wherein at least one of the ceiling, back wall, two side walls or front wall is insulated.

3. The portable cadaver rack housing of claim 1 comprising a refrigeration device connected to the one or more ports.
